(19) United States
(12) Patent Application Publication
(10) Pub. No.: US 2025/0166068 A1
(43) Pub. Date: May 22, 2025

(54) SWAP MARKET TERM PREMIUM AND DISCOUNT RATE ESTIMATION AND IMPLEMENTATION BASED ON MARKET DATA

(71) Applicants: Ms Angelina Chakravarti, London (GB); Ljubica Gerogievska, London (GB)

(72) Inventors: Ms Angelina Chakravarti, London (GB); Ljubica Gerogievska, London (GB)

(21) Appl. No.: 18/955,805

(22) Filed: Nov. 21, 2024

Related U.S. Application Data
(60) Provisional application No. 63/601,673, filed on Nov. 21, 2023.

(51) Int. Cl. G06Q 40/04

(52) U.S. Cl. CPC G06Q 40/04

(57) ABSTRACT

A method of the present disclosure includes receiving market data that includes a current market condition. The current market condition includes at least one of: an interest rate, a bond price, a swap rate, a swaption premium, a swaption volatility surface, a cap rate, a cap volatility surface, a floor rate, a floor volatility surface, or a combination thereof. The method includes receiving additional data that includes a future market condition. The future market condition includes at least one of: an economic indicator, a market structure metric, a supply-demand factor, or a combination thereof. The method includes estimating a swap market term premium by inputting the current market condition and the future market condition into a factor model. The method includes generating a report based at least in part on the estimated swap market term premium. The method includes transmitting the report to a trading system.

### CROSS-REFERENCES TO RELATED APPLICATIONS

This application claims the benefit of U.S. Provisional Patent Application No. 63/601,673 entitled “HAIRY PREMIUM: IDENTIFICATION, ESTIMATION, AND CAPTURE SYSTEM AND METHOD” and filed on Nov. 21, 2023 for Angelina Chakravarti, which is incorporated herein by reference.

### FIELD

This invention relates to Swap market term premium and discount rate estimation and more particularly relates to Swap market term premium and discount rate estimation and implementation based on market data.

### BACKGROUND

Interest rate swaps (“IRS”) and related derivative instruments aid in the exchange of streams of interest rates. The pricing of these instruments relies on discount rates calibrated to maintain no-arbitrage conditions relative to government bond markets.

### SUMMARY

An apparatus for estimating a swap market term premium is disclosed. The apparatus includes a market data module that receives market data. The market data includes a current market condition. The current market condition includes at least one of: an interest rate, a bond price, a swap rate, a swaption premium, a swaption volatility surface, a cap rate, a cap volatility surface, a floor rate, a floor volatility surface, or a combination thereof. The apparatus includes a future data module that receives additional data. The additional data includes a future market condition. The future market condition includes at least one of: an economic indicator, a market structure metric, a supply-demand factor, or a combination thereof. The apparatus includes a premium module that estimates a swap market term premium by inputting the current market condition and the future market condition into a factor model. The apparatus includes a report module that generates a report based at least in part on the estimated swap market term premium. The report includes one or more investment instructions. The report module transmits the report to a trading system. At least a portion of said modules include one or more of hardware circuits, programmable hardware circuits and executable code, the executable code stored on one or more computer readable storage media. The subject matter of the preceding paragraph constitutes example 1 of the present disclosure.

According to example 2 of the present disclosure, which encompasses example 1, the apparatus includes an investment instructions module that generates the investment instructions by determining a change in a relationship between a bond price, a discount interest rate, and a swap rate based at least in part on the estimated swap market term premium.

According to example 3 of the present disclosure, which encompasses any of examples 1-2, the premium module estimates the swap market term premium at a first time. The apparatus further includes a machine learning module that predicts a swap market term premium at a second time subsequent to the first time by inputting the current market condition and the future market condition into a machine learning model. The machine learning model is trained on historical data. The historical data includes a realized swap market term premium. The report further includes the predicted swap market term premium.

According to example 4 of the present disclosure, which encompasses any of examples 1-3, the apparatus includes an error module that determines an error in the predicted swap market term premium by comparing the predicted swap market term premium to a realized swap market term premium and refines the machine learning model based at least in part on the determined error. The apparatus includes a learning rate module that adjusts a learning rate of the machine learning model based at least in part on the determined error.

According to example 5 of the present disclosure, which encompasses any of examples 1-4, the apparatus includes a confidence module that generates a confidence interval for the predicted swap market term premium based at least in part on at least one of: the future market condition, the current market condition, estimated swap market term premium, a realized swap market term premium, a calculated uncertainty of the predicted swap market term premium, or a combination thereof.

According to example 6 of the present disclosure, which encompasses any of examples 1-5, above, the apparatus includes a performance module configured to continuously monitor a performance of the machine learning model. The machine learning module updates the predicted swap market term premium based at least in part on the monitored performance of the machine learning model.

According to example 7 of the present disclosure, which encompasses any of examples 1-6, above, the apparatus includes a monitoring module that continuously monitors the market data and the additional data in real-time. The apparatus includes an update module that iteratively updates the estimated swap market term premium based at least in part on the monitored market data and the monitored additional data.

According to example 8, which encompasses any of examples 1-7, above, the apparatus includes a user interface module that generates a graphical user interface (“GUI”), the graphical user interface comprising an indication of the estimated swap market term premium, and automatically updates the indication in response to the update module updating the estimated swap market term premium.

According to example 9, which encompasses any of examples 1-8, above, the apparatus includes an alert module that automatically transmits an alert to a computing device associated with a user in response to the update module updating the estimated swap market term premium.

According to example 10, which encompasses any of examples 1-9, above, the swap market term premium module computes, based at least in part on the current market condition, at least one of: a level factor, a slope factor, a curvature factor, a principal component factor, or a combination thereof. The apparatus further includes a multi-factor regression module that generates a multi-factor regression model for estimating the swap market term premium by performing multi-factor regression analysis based at least in part on the current market condition, a future market condition, and a realized swap market term premium. The apparatus includes a premium module that estimates the swap market term premium based at least in part on an output of the multi-factor regression module.

According to example 11, which encompasses any of examples 1-10, the apparatus includes a discount factor module that adjusts a standard discount factor based at least in part on the estimated swap market term premium. The apparatus includes a rate modification module that adjusts a forward rate factor based at least in part on the adjusted standard discount factor, a received market price, or a combination thereof. The apparatus includes a no-arbitrage check module that, in response to the rate modification module adjusting the forward rate factor, determines whether a no-arbitrage condition is maintained based at least in part on the adjusted standard discount factor. The apparatus includes a market consistency module that, in response to the rate modification module adjusting the forward rate factor, determines whether a market consistency condition is maintained based at least in part on the adjusted forward rate factor.

According to example 12, which encompasses any of examples 1-11, above, in response to the no-arbitrage check module determining that the no-arbitrage condition is not maintained, the discount factor adjustment module further adjusts the adjusted standard discount factor. In response to the market consistency module determining that the market consistency condition is not maintained, the rate modification module further adjusts the forward rate factor.

According to example 13, which encompasses any of examples 1-12, above, the apparatus further includes a discount curve module that automatically generates an adjusted discount curve based at least in part on the adjusted forward rate factor and the adjusted discount factor in response to the no-arbitrage check module determining that the no-arbitrage condition is maintained and the market consistency module determining that the market consistency condition is maintained. The discount curve module outputs the generated adjusted discount curve to at least one of: a graphical user interface (“GUI”), the report module, an alert module configured to transmit a notification indicating the adjusted discount curve to the user, or a combination thereof.

According to example 14, which encompasses any of examples 1-13, above, the standard discount factor module adjusts the standard discount factor by applying an exponential premium adjustment to a standard discount factor and modifying an interest rate based at least in part on the estimated swap market term premium.

According to example 15, which encompasses any of the examples 1-14, above, the apparatus includes a fair market value module that determines a fair market value of an interest rate derivative by applying the generated adjusted discount curve. The apparatus includes a risk metric module that computes a risk metric based at least in part on the generated adjusted discount curve. The report further includes the determined fair market value, the risk metric, and the estimated swap market term premium.

According to example 16, which encompasses any of examples 1-15, above, the apparatus includes an at-the-money forward rate module that determines an at-the-money forward rate based at least in part on the estimated swap market term premium. The apparatus includes a caplet sale module that sells a first caplet, the first caplet having an interest rate equal to a difference between the at-the-money forward rate and the estimated swap market term premium and receives, in response to selling the first caplet, a first caplet premium. The apparatus includes a caplet purchase module that purchases a second caplet concurrently with the caplet sale module selling the first caplet, wherein the second caplet has an interest rate equal to the at-the-money forward rate, and pays, in response to buying the second caplet, a second caplet premium. The apparatus includes a premium collection module that receives a net caplet premium. The net caplet premium is based at least in part on a difference between the first caplet premium and the second caplet premium.

According to example 17, which encompasses any of examples 1-16, above, the apparatus includes a risk limit module that, based at least in part on the net caplet premium, quantifies a risk and determines whether the risk is greater than or equal to a threshold risk. The swap market term premium module updates the estimated swap market term premium in response to the risk limit module determining that the risk is greater than or equal to the threshold risk.

According to example 18, which encompasses any of examples 1-17, above, the apparatus includes a strategy execution module configured to generate and execute a strategy in response to the risk limit module determining that the risk is less than the threshold risk. Executing the strategy includes at least one of: purchasing a caplet, selling a caplet, receiving a premium, paying a premium, performing a transaction, or a combination thereof.

The subject matter of the following paragraph constitutes example 19 of the present disclosure. According to example 19, a method includes receiving market data. The market data includes a current market condition. The current market condition includes at least one of: an interest rate, a bond price, a swap rate, a swaption premium, a swaption volatility surface, a cap rate, a cap volatility surface, a floor rate, a floor volatility surface, or a combination thereof. The method includes receiving additional data. The additional data includes a future market condition. The future market condition includes at least one of: an economic indicator, a market structure metric, a supply-demand factor, or a combination thereof. The method includes estimating a swap market term premium by inputting the current market condition and the future market condition into a factor model. The method includes generating a report based at least in part on the estimated swap market term premium. The report includes one or more investment instructions. The method includes transmitting the report to a trading system.

The subject matter of the following paragraph constitutes example 20 of the present disclosure. Example 20 includes a computer program product. The computer program product includes a computer readable storage medium storing code, the code being configured to be executable by a processor to perform operations. The operations include receiving market data. The market data includes a current market condition. The current market condition includes at least one of: an interest rate, a bond price, a swap rate, a swaption premium, a swaption volatility surface, a cap rate, a cap volatility surface, a floor rate, a floor volatility surface, or a combination thereof. The operations include receiving additional data. The additional data includes a future market condition. The future market condition includes at least one of: an economic indicator, a market structure metric, a supply-demand factor, or a combination thereof. The operations include estimating a swap market term premium by inputting the current market condition and the future market condition into a factor model. The operations include generating a report based at least in part on the estimated swap market term premium. The report includes one or more investment instructions. The operations include transmitting the report to a trading system.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating one embodiment of a system;

FIG. 2 is a schematic block diagram illustrating one embodiment of a Swap market term premium apparatus;

FIG. 3 is a schematic block diagram illustrating one embodiment of a Swap market term premium apparatus for estimating a Swap market term premium using machine learning;

FIG. 4 is a schematic flow chart illustrating one embodiment of a method of estimating and reporting a Swap market term premium;

FIG. 5 is a schematic flow chart illustrating one embodiment of a method of estimating a Swap market term premium using machine learning;

FIG. 6 is a schematic flow chart illustrating one embodiment of a method of adjusting a discount curve;

FIG. 7 is a schematic flow chart illustrating one embodiment of a method of executing an investment strategy; and

FIG. 8 is a schematic flow chart illustrating one embodiment of a method of refining a machine learning model.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Interest rate swaps (“IRS”) and related derivative instruments help to facilitate exchange of streams of interest rates in modern financial markets. The pricing of these instruments relies heavily on discount rates calibrated to maintain no-arbitrage conditions relative to government bond markets. However, current pricing and trading models may not fully capture certain market dynamics and risk factors, particularly regarding pricing of duration risk and market frictions. Traditional approaches assume equivalence between various trading strategies, such as shorting government bonds versus shorting Floating Rate Notes (FRNs), or rolling over T-bills versus holding FRNs. These assumptions may not hold consistently in practice, leading to potential systematic mispricing. Examples of the present disclosure includes systems and methods that help to more accurately estimate Swap market term premium in interest rate markets, adjust discount rates used in derivatives pricing, account for market segmentation and distinct risk-sharing mechanisms, and/or capture discrepancies between long and short-duration risk assessments.

As used herein, the term “swap market term premium” refers to a term premium in a swap market. The term “swap market term premium” may be used interchangeably herein with the term “Hairy premium.” The Swap market term premium is the annualized return from receiving fixed rate payments in exchange for floating rate payments over a specified horizon in an interest rate swap, held to maturity. Mathematically, it is defined as:

$$h {p}_{t , N}^{( N )} = {y}_{t}^{( N )} - \frac{1}{N} {\sum }_{n = i}^{N} {r}_{t + n - 1}^{( 1 )} , \qquad ( 1 )$$

where in this formula, hp_{t,N}^{(N)} represents the N-term Swap market term premium measured at time t, yₜ^{(N)} indicates the annualized N-year fixed swap rate at time t, and rₜ₊ₙ¹ denotes the floating reference rate (such as 3-month London Interbank Offered Rate (“LIBOR”)), with the first subscript t indicating measurement time and the second subscript n denoting the realization horizon over which the premium is calculated. The summation term Σₙ₌₁^{N}rₜ₊ₙ¹ represents a sum of the realized floating rates from period t to t+N−1, with the (1/N) factor converting this sum to an annual average.

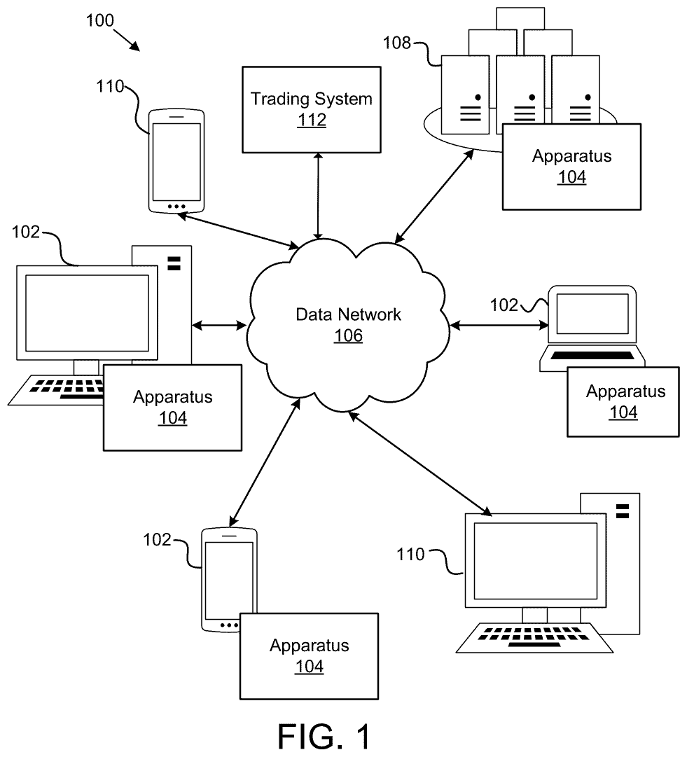

FIG. 1 is a perspective view illustrating one example of a system 100 for Swap market term premium and discount rate estimation and implementation based on market data. In some examples, the system 100 includes a comprehensive, computer-implemented framework configured to estimate and predict Swap market term premium through real-time market data analysis. In some examples, the system 100 is configured to process market data feeds, implement machine learning algorithms for premium estimation, maintain continuous monitoring, and/or generate actionable trading inputs based on the estimated premium values.

As shown in FIG. 1, the system 100 includes at least one Swap market term premium apparatus 104 and a data network 106. The at least one Swap market term premium apparatus 104 is connected to the data network 106. The Swap market term premium apparatus 104 includes an apparatus configured to perform at least one of the following functions: estimation of Swap market term premium, training of a machine learning model for estimating Swap market term premium, discount curve adjustment, and/or Swap market term premium reporting. Although not shown in FIG. 1, in some examples, the system 100 also includes a user device connected to at least one Swap market term premium apparatus 104 via the data network 106. The user device, for example, includes an information handling device configured to view and/or share outputs received from a Swap market term premium apparatus 104.

The Swap market term premium apparatus 104, in some examples, includes a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one example, the Swap market term premium apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the Swap market term premium apparatus 104.

The semiconductor integrated circuit device or other hardware appliance of the Swap market term premium apparatus 104, in certain examples, includes and/or is communicatively coupled to one or more volatile memory media, which may include but is not limited to random access memory (“RAM”), dynamic RAM (“DRAM”), cache, or the like. In one example, the semiconductor integrated circuit device or other hardware appliance of the Swap market term premium apparatus 104 includes and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one example, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one example, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one example, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102. For instance, a server 108 may be an intermediary between information handling devices 102 to facilitate sending and receiving electronic messages between the information handling devices 102.

In some examples, an information handling device 102 on which the apparatus 104 is deployed is in communication with an additional information handling device 110 over a connection to the data network 106. In some examples, the additional information handling device 110 is associated with a user, and the apparatus 104 is configured to present a user interface to be accessed by the user via the additional information handling device 110.

In some examples, a trading system 112 is connected to the data network 106. In some examples, the trading system 112 provides data to the Swap market term premium apparatus 104. In some examples, the trading system 112 receives output from the Swap market term premium apparatus 104 and/or implements a strategy based on outputted instructions from the Swap market term premium apparatus 104. In some examples, the trading system 112 includes an automated trading system (“ATS”). In some examples, the trading system 112 is configured to automatically submit orders to a market center and/or exchange.

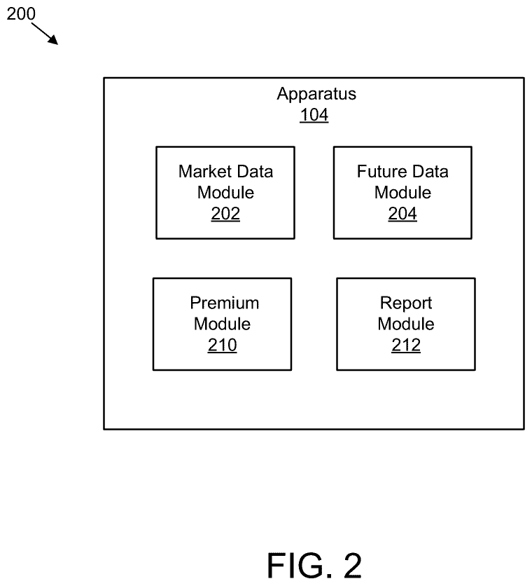

FIG. 2 is a schematic block diagram illustrating one example of an apparatus 200 for Swap market term premium estimation. In some examples, the apparatus 200 includes the Swap market term premium apparatus 104. The swap market term premium apparatus 104, in some examples, includes one or more of a market data module 202, a future data module 204, a swap market term premium module 210, and a report module 212, which are described in more detail below.

In some examples, the market data module 202 receives market data. For example, the market data module 202 receives market data over the data network 106. The market data module 202 receives, in various examples, market data from one or more the trading system 112, an information handling device 102, a user device 110, and/or a combination thereof.

In some examples, the market data includes a current market condition. In some examples, the current market condition includes at least one of: an interest rate, a bond price, a swap rate, a swaption premium, a swaption volatility surface, a cap rate, a cap volatility surface, a floor rate, a floor volatility surface, or a combination thereof.

In some examples, the market data includes data relating to one or more interest rate markets. In some examples, the market data module 202 receives market data from an interest rate feed, such as the Treasury Daily Interest Rate Feed. In some examples, the market data module 202 receives real-time updates to the interest rate market data. In some examples, the market data includes at least one of: an interest rate, a bond price, a swap rate, a bond yield, a central bank rate, an interbank rate, a mortgage rate, or a combination thereof. In some examples, the market data includes spot rates across various maturities, forward rates, and swaption-implied rates across various maturities, incorporating both premium information and implied volatility data. In some examples, the market data module 202 is configured to receive market data from bond market feeds.

In some examples, the market data module 202 is configured to receive market data in any format and convert them into at least one of the following formats: Extensible Markup Language (“XML”), JavaScript Object Notation (“JSON”), Comma-Separated Values (“CSV”), Excel (“XLS”), text (“TXT”), or any combination thereof.

In some examples, the market data module 202 is configured to obtain the market data from an incoming market feed. In some examples, the market data module executes quality validation and/or pre-processing steps to help remove anomalies form the received market data. In some examples, the market data module 202 then converts the market data into a different format from a format in which it was received, such as any of the formats described above. In some examples, the market data module 202 subjects the data to additional standardization and orthogonalization procedures after converting the data into the different format.

The future data module 204 is configured to receive additional data. In some examples, the additional data includes a future market condition. In some examples, the future market condition includes at least one of: an economic indicator, a market structure metric, a supply-demand factor, or a combination thereof.

The additional data includes, in some examples, external data that is separate from the market data received by the market data module 202. In some examples, the additional data includes at least one of: an economic indicator, a macroeconomic indicator, gross domestic product, an inflation rate, an unemployment rate, a market structure metric, supply, demand factor, market liquidity, or a combination thereof. In some examples, the additional data includes Treasury Holdings Data segmented by maturity, Treasury market operations metrics, Federal Reserve SOMA holdings, dealer constraints, broader economic indicators, or a combination thereof.

In some examples, the additional data includes Treasury Holdings Data segmented by remaining maturity (e.g., under 1 year, 1-5 years, 5-10 years, and over 10 years), with distinct treatment of fixed-rate securities and floating rate notes. In some examples, the additional data includes Treasury Floating Rate Note (FRN) issuance data, measures of debt rollover clustering, detailed Treasury market operations, bid-to-cover ratios, dealer takedown shares, yield spreads to when-issued trading levels, or a combination thereof. In some examples, the additional data includes Treasury's quarterly refunding announcements, secondary market Treasury yields and prices, Federal Reserve System Open Market Account (“SOMA”) holdings reports, or a combination thereof. In some examples, the SOMA holdings reports include security-level information relating to purchase timing, size, maturity, or a combination thereof. In some examples, the additional data includes measures of investor demand concentration, dealer constraints (e.g., proxied by VIX levels, primary dealer leverage ratios, aggregate fails-to-deliver, or a combination thereof) along with broader economic indicators, such as Gross Domestic Product (“GDP”), inflation, unemployment, monetary policy indicators, Qualified Entity (“QE”) program data, or a combination thereof.

The premium module 210 is configured to, in some examples, determine a spot factor, a forward-looking factor, and/or a combination thereof based at least in part on the market data, the additional data, and/or a combination thereof. The spot factor includes a factor that represents a current market condition. The forward-looking factor, or forward factor, represents future market expectations. In some examples, the premium module 210 is configured to determine the spot factor and forward-looking factor based at least in part on factors affecting interest rate markets, such as the structural factors and market dynamics described above in connection with the market data module 202 and the future data module 204.

In some examples, the premium module 210 determines and/or generates the spot and/or forward-looking factors jointly through Principal Component Analysis (PCA) of a comprehensive dataset, such as a dataset including the market data and/or the additional data. In some examples, the spot factor and/or forward-looking factor is a Principal Component (“PC”) resulting from the PCA. In some examples, each PC captures a distinct pattern of variation in the data.

In some examples, the Swap market term premium module 210 is configured to estimate a Swap market term premium. In some examples, the swap market term premium module 210 is configured to estimate a swap market term premium by inputting the current market condition and the future market condition into a factor model.

In some examples, the Swap market term premium module 210 is configured to estimate the Swap market term premium by inputting the spot and forward-looking factors determined by the premium module 210 into a factor model and estimating Swap market term premium using the factors and historical realized Swap market term premium.

In some examples, the Swap market term premium module 210 is configured to estimate the Swap market term premium based at least in part on at least one of: an average annualized realized cost of rolling over a short-term floating rate, an average annualized realized cost of the long-term N-year fixed rate over an entire time (t) to N-year holding, or a combination thereof. In some examples, the Swap market term premium module 210 calculates the Swap market term premium by subtracting the predicted average annualized realized cost of rolling over the short-term floating rate from the predicted average annualized realized cost of the long-term N-year fixed rate, as shown in the following equation:

$$h {p}_{t}^{N} = {y}_{t}^{( N )} - \frac{1}{N} {\sum }_{n = 1}^{N} {r}_{t + n - 1}^{( 1 )} , \qquad ( 1 )$$

where yₜ^{(N)} indicates the annualized holding period log return on an N-term fixed rate and rₜ⁽¹⁾ denotes the annualized holding period log return on the short-term floating rate. In some examples, the Swap market term premium can be expressed as:

$$H {P}_{t}^{( N )} = exp \{ ( h {p}_{t}^{N} ) \} . \qquad ( 2 )$$

In some examples, the Swap market term premium module 210 is configured to estimate the Swap market term premium based at least in part on at least one of: an expected excess bond return, an expected excess bond return decay, structural persistence in excess bond returns, expected governmental regime changes, non-linear risk pricing effects, or a combination thereof.

In some examples, the Swap market term premium module 210 is configured to estimate the Swap market term premium using at least one of the following models: a factor model, a LIBOR market model, an affine term structure model, a Heath-Jarrow-Morton model, a general equilibrium model, or a combination thereof.

In some examples, the swap market term premium module 210 is configured to estimate a swap market term premium using a statistical analysis. In some examples, the swap market term premium module 210 estimates the swap market term premium without receiving any market data. In some examples, the swap market term premium module 210 calculates and/or receives realized swap market term premium data that includes at least one realized swap market term premium. In various examples, the term premium module 210 extracts one or more patterns from the realized swap market term premium data. In some examples, the term premium module 210 inputs the one or more extracted patterns into a model, such as a term structure model (e.g., a LIBOR model). In various examples, the term premium module 210 determines an interest rate based at least in part on an output of that model. In various examples, the term premium module 210 estimates a swap market term premium based at least in part on the determined interest rate.

The report module 212 is configured to generate a report based at least in part on the Swap market term premium estimated by the premium module 210. In some examples, the report includes one or more investment instructions. In some examples, the report module 212 is configured to transmit the report to the trading system 112. In some examples, the report module 212 is configured to use the Swap market term premium estimated by the Swap market term premium module 210 as an input for a trading system 112.

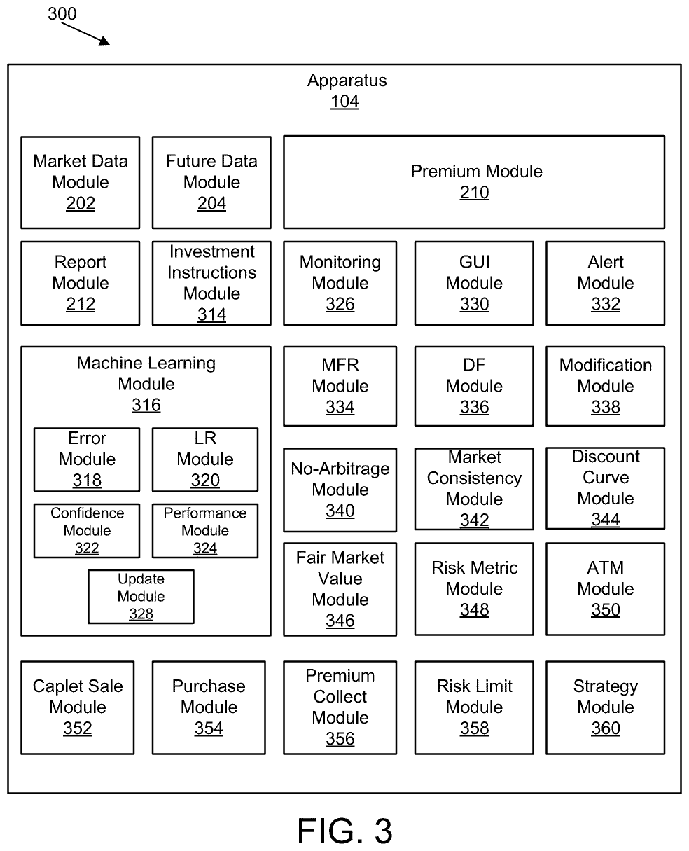

FIG. 3 is a schematic block diagram illustrating one example of an apparatus 300 for Swap market term premium estimation. In some examples, the apparatus 300 includes an example of the apparatus 200 and of a Swap market term premium apparatus 104. The Swap market term premium apparatus 104, in some examples, includes one or more of a market data module 202, an future data module 204, a premium module 210, and a report module 212, as described in connection with FIG. 2. In some examples, the Swap market term premium apparatus 104 additionally includes an investment instructions module 314, machine learning module 316, error module 318, a learning rate module 320, a confidence module 322, a performance module 324, a monitoring module 326, an update module 328, a graphical user interface (“GUI”) module 330, an alert module 332, a multi-factor linear regression module 334, a discount factor module 336, a modification module 338, a no-arbitrage module 340, a market consistency module 342, a discount curve module 344, a fair market value module 346, a risk metric module 348, an at-the-money (“ATM”) forward rate module 350, a caplet sale module 352, a purchase module 354, a premium collection module 356, a risk limit module 358, a strategy module 360, and/or a combination thereof.

The investment instructions module 314 is configured to generate the investment instructions by determining a change in a relationship between a bond price, a discount interest rate, and a swap rate based at least in part on the estimated swap market term premium.

In some examples, the Swap market term premium module 210 is configured to predict a Swap market term premium based at least in part on output from the machine learning module 316. The machine learning module 316, in some examples, is configured to update the Swap market term premium estimated by the premium module 210. In other examples, the machine learning module 316 is configured to make the original Swap market term premium estimation. In some examples, the machine learning module 316 is configured to update the estimated Swap market term premium by inputting the spot factor determined and the forward factor determined by the premium module 210 into a machine learning model.

In some examples, the premium module 210 is configured to estimate the swap market term premium at a first time (e.g., t=0). In some examples, the machine learning module 316 is configured to predict a swap market term premium at a second time subsequent to the first time (e.g., t=1) by inputting the current market condition and the future market condition into the machine learning model.

In some examples, the machine learning model is trained on historical data. In some examples, the historical data includes a realized swap market term premium. In some examples, the report transmitted by the report module 212 includes the predicted swap market term premium.

In some examples, the historical data includes the market data received by the market data module 202. In some examples, the historical data includes additional market data. In some examples, the historical data includes the additional data received by the future data module 204. In some examples, the historical data includes realized Swap market term premiums over a past time period. In some examples, the historical data includes spot and/or forward factors over various maturities. In some examples, the machine learning model is trained on data that includes regime indicators and market stress indicators.

The error module 318 is configured to determine an error in the predicted swap market term premium predicted by the machine learning module 316. In some examples, the error module 318 is configured to determine the error by comparing the predicted swap market term premium to a realized swap market term premium. In some examples, the realized swap market term premium is realized subsequent to the prediction. In some examples, the error module 318 refines the machine learning model based at least in part on the determined error.

In some examples, the error module 318 is configured to employ Root Mean Square Error (RMSE) monitoring to optimize the machine learning model. In some examples, the error module 318 continuously monitors and evaluates Swap market term premium prediction accuracy across different market regimes and time horizons.

In some examples, the error module 318 is configured to determine an error based at least in part on a difference between the estimated Swap market term premium and a subsequently realized Swap market term premium. In some examples, the error module 318 is configured to calculate the subsequently realized Swap market term premium using equations comparable to equations (1) and/or (2) above with actual, realized values as inputs.

The learning rate module 320 adjusts a learning rate of the machine learning model based at least in part on the error determined by the error module 318.

The confidence module 322 is configured to generate a confidence interval for the predicted swap market term premium. In some examples, the confidence module 322 generates the confidence interval based at least in part on at least one of: the future market condition, the current market condition, the estimated swap market term premium, a realized swap market term premium, a calculated uncertainty of the predicted swap market term premium, model uncertainty, market volatility, or a combination thereof. In some examples, the confidence module 322 is configured to incorporate historical estimation errors, current market conditions, regime-specific volatility patterns, or a combination thereof to produce time-varying confidence bands that adjust to changing market environments.

The performance module 324 is configured to continuously monitor a performance of the machine learning model. In some examples, the machine learning module 316 updates the estimated premium based at least in part on the monitored performance of the machine learning model.

The monitoring module 326 is configured to continuously monitor the market data received by the market data module 202 and the additional data received by the future data module 204 in real-time. In some examples, the monitoring module 326 is configured to continuously monitor at least one of: market data feeds, interest rates, swap rates, bond prices, option prices, external data sources, Federal Reserve actions, Treasury market operations, economic indicators, market structure metrics, or any combination thereof.

The update module 328 iteratively updates the estimated Swap market term premium based at least in part on the data monitored by the monitoring module 326.

The user interface module 330 is configured to generate a user interface, such as a graphical user interface (“GUI”). In some examples, the GUI includes an indication of the estimated swap market term premium. In some examples, the GUI includes a dashboard including an indication of the estimated Swap market term premium. In some examples, the user interface module 330 automatically updates the indication in response to the update module 328 updating the estimated swap market term premium. As such, in some examples, the interface module 330 is configured to provide a dashboard that provides an estimated Swap market term premium that is based on real-time monitoring of market data.

The alert module 332 is configured to automatically transmit an alert to a computing device associated with a user in response to the update module updating the estimated swap market term premium.

In some examples, the multi-factor regression module 334 is configured to generate a multi-factor regression model for estimating the swap market term premium by performing multi-factor regression analysis based at least in part on the current market condition, a future market condition, and a realized swap market term premium. In some examples, the premium module 210 estimates the swap market term premium based at least in part on an output of the multi-factor regression module. In some examples, the multi-factor regression model uses a realized swap market term premium as a dependent variable and at least one of the following as an independent variable: a spot factor, a forward factor, a current market condition, a future market condition, or a combination thereof.

In one or more examples, the multi-factor regression module 334 is configured to generate a model for predicting a Swap market term premium by performing multi-factor regression analysis based on the spot factor, the forward factor, and the estimated Swap market term premium. In some examples, the generated model is a multi-factor regression model. In some examples, the multi-factor regression module 334 is configured to estimate an additional Swap market term premium using the model. In some examples, the premium module 210 is configured to estimate the Swap market term premium based on the multi-factor regression model. In some examples, the multi-factor regression module 334 is configured to use factors derived by the premium module 210 using PCA to generate a Swap market term premium estimate. In some examples, the Swap market term premium module 210 is configured to compute, based at least in part on the current market condition, at least one of: a level factor, a slope factor, a curvature factor, a principal component factor, or a combination thereof. In some examples, the multi-factor regression module 334 is configured to use at least one of these factors computed by the Swap market term premium module 210 to generate the multi-factor regression model.

In some examples, the multi-factor regression module 334 is configured to use the multi-factor regression model to regress excess returns for a more accurate prediction of Swap market term premium. In some examples, regressing the excess returns includes analyzing a historical relationship between realized returns and factors derived by the premium module 210. This analysis can help to quantify how different market conditions and factor combination contribute to premium generation, allowing for more accurate predictions of future Swap market term premium levels.

The discount factor module 336 is configured to adjust a standard discount factor based at least in part on the Swap market term premium estimated by the Swap market term premium module 210. In some examples, the discount factor module 336 adjusts the standard discount factor by applying an exponential premium adjustment to a standard discount factor. In some examples, the adjusted discount factor is expressed as follows:

$${D}_{adjusted} ( t , T ) = {D}_{standard} ( t , T ) exp ( H {P}_{t}^{∧ T - t} ) , \qquad ( 3 )$$

where D_{standard}(t,T) represents the standard discount rate and HP\hat{ } represents an estimated Swap market term premium. T represents the future maturity date of the instrument being discounted. t represents the current time of estimation. The difference T−t represents the time horizon over which the Swap market term premium adjustment is applied to the standard discount factor.

In some examples, the discount factor module 336 modifies an interest rate based at least in part on the Swap market term premium estimated by the premium module 210. In some examples, the adjusted interest rate is expressed as follows:

$${r}_{adjusted} ( t , T ) = {r}_{standard} ( t , T ) - H {P}_{t}^{∧ T - t} , \qquad ( 4 )$$

where r_{standard} represents the standard interest rate.

The rate modification module 338 is configured to adjust the forward rate factor based at least in part on the adjusted standard discount factor, a received market price, or a combination thereof.

The no-arbitrage module 340 is configured to, in response to the rate modification module 338 adjusting the forward rate factor, determine whether a no-arbitrage condition is maintained based at least in part on the adjusted standard discount factor.

In some examples, the discount factor adjustment module 336 is configured to further adjust the adjusted standard discount factor in response to the no-arbitrage check module determining that the no-arbitrage condition is not maintained.

The market consistency module 342 is configured to, in response to the rate modification module adjusting the forward rate factor, determine whether a market consistency condition is maintained based at least in part on the adjusted forward rate factor.

In some examples, in response to the market consistency module determining that the market consistency condition is not maintained, the rate modification module 338 further adjusts the forward rate factor.

In some examples, the discount curve module 344 is configured to generate and/or adjust a discount curve based at least in part on an estimated Swap market term premium, such as a Swap market term premium estimated by the Swap market term premium module 210 based at least in part on an output from the machine learning module 316.

In some examples, the discount curve module 344 is configured to automatically generate an adjusted discount curve based at least in part on the adjusted forward factor determined by the rate modification module 338 and the adjusted discount factor determined by the discount factor module 336 in response to the no-arbitrage check module 340 determining that the no-arbitrage condition is maintained and the market consistency module 342 determining that the market consistency condition is maintained. In some examples, the no-arbitrage condition includes a condition in which the adjusted discount factors maintain consistent pricing relationships across different maturities and instruments. In some examples, the no-arbitrage check module 340 is configured to verify that no risk-free profit opportunities exist after applying the Swap market term premium adjustments to the discount curve. In some examples, the no-arbitrage check module 340 is configured to check that forward factor implied by any two discount factors are consistent with directly quoted market forward factors after accounting for the Swap market term premium adjustment.

In some examples, the discount curve module 344 outputs the generated adjusted discount curve to at least on of: a GUI (e.g., a GUI generated by the user interface module 330), the report module 212, the alert module 332, or a combination thereof. In some examples, the alert module 332 transmits a notification of the adjusted discount curve to a user device 110.

The fair market value module 346 is configured to determine a fair market value of an interest rate derivative by applying the generated adjusted discount curve.

The risk metric module 348 is configured to compute a risk metric based at least in part on the generated adjusted discount curve. In some examples, the report generated by the report module 212 includes the risk metric determined by the risk metric module 348, the fair market value determined by the fair market value module 346, and the Swap market term premium estimated by the Swap market term premium module 210 and/or updated by the machine learning module 316.

The at-the-money forward rate module 350 is configured to determine an at-the-money forward rate based at least in part on the estimated Swap market term premium.

The caplet sale module 352 is configured to sell a first caplet. The first caplet has an interest rate equal to a difference between the at-the-money forward rate and the estimated Swap market term premium. The caplet sale module receives, in response to selling the first caplet, a first caplet premium. In some examples, the caplet sale module 352 is configured to generate a simulation based on historical data, and the caplet sale includes a simulated caplet sale. In some examples, the caplet sale module 352 is configured to perform an actual sale of a caplet in the market over a data network 106.

The caplet purchase module 354 is configured to purchase a second caplet concurrently with the caplet sale module 352 selling the first caplet. In some examples, the second caplet has an interest rate equal to an at-the-money forward rate, such as the at-the-money forward rate calculated by the at-the-money forward rate module 350. In some examples, the caplet purchase module 354 is configured to purchase the second caplet in a simulated purchase. In other examples, the caplet purchase module 354 actuates a purchase of the second caplet over the data network 106.

The caplet purchase module 354 is configured to pay, in response to buying the second caplet, a second caplet premium.

The premium collection module 356 is configured to receive a net caplet premium. In some examples, the net caplet premium is based at least in part on a difference between the first caplet premium and the second caplet premium.

In some examples, the risk limit module 358 is configured to, based at least in part on the net caplet premium, quantify a risk and determine whether the risk is greater than or equal to a threshold risk. In some examples, the Swap market term premium module 210 updates the estimated Swap market term premium in response to the risk limit module determining that the risk is greater than or equal to the threshold risk.

The strategy module 360 is configured to generate and execute a strategy in response to the risk limit module 358 determining that the risk is less than the threshold risk.

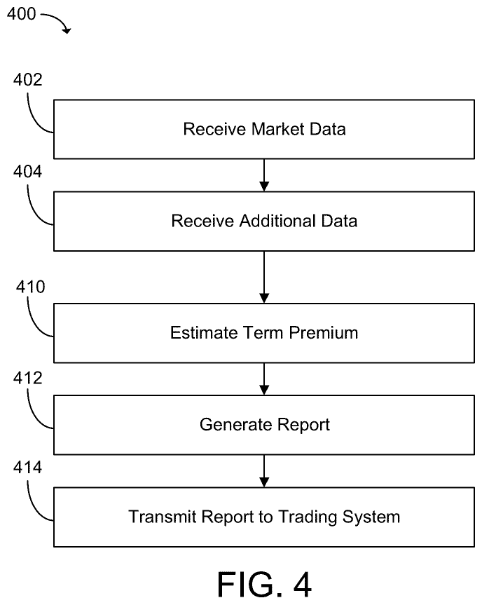

FIG. 4 is a schematic flow chart illustrating one embodiment of a method 400 of estimating and reporting a Swap market term premium. In some examples, the method 400 begins and includes a step 402 of receiving market data. The market data includes a current market condition. The current market condition includes at least one of: an interest rate, a bond price, a swap rate, a swaption premium, a swaption volatility surface, a cap rate, a cap volatility surface, a floor rate, a floor volatility surface, or a combination thereof. The method 400 includes a step 404 of receiving additional data. The additional data includes a future market condition. The future market condition includes at least one of: an economic indicator, a market structure metric, a supply-demand factor, or a combination thereof. The method 400 includes a step 410 of estimating a Swap market term premium by inputting the current market condition and the future market condition into a factor model. The method 400 includes a step 412 of generating a report based at least in part on the estimated Swap market term premium. The report includes one or more investment instructions. In some examples, the method 400 includes a step 414 of transmitting the report to a trading system 112.

In some examples, some or all steps of the method 400 are implemented by module(s) of the apparatus 200 and/or 300.

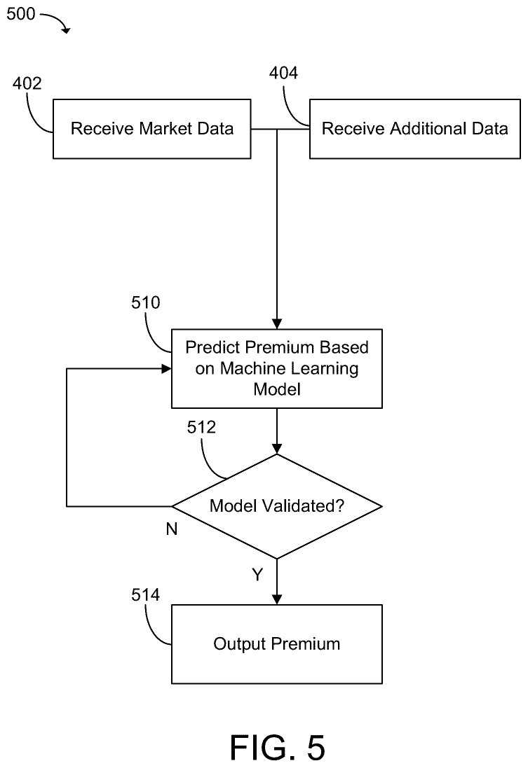

FIG. 5 is a schematic flow chart illustrating one embodiment of a method 500 of estimating a Swap market term premium using machine learning. In some examples, the method 500 is an embodiment of the method 400 and includes the steps 402, 404, 406, and/or 408 of the method 400. In some examples, the method 500 additionally includes a step 510 of estimating the Swap market term premium based at least in part on a machine learning model. In some examples, the method 500 inputs the determined spot factor and forward factor into a machine learning model to estimate a Swap market term premium. In some examples, the method 500 includes a step 512 of determining whether the machine learning model is validated.

In some examples, determining 512 whether the machine learning model is validated includes at least one of: comparing predictions from the machine learning model to historical data, estimating impact of a set of economic conditions influencing a current or future period in the market, estimating stability of the predicted Swap market term premium, or a combination thereof. In some examples, determining 512 whether the machine learning model is validated includes: historical backtesting against realized Swap market term premium values, out-of-sample performance evaluation across different market regimes, stress testing under various economic scenarios, stability analysis of predictions across different time horizons, examining the model's adaptability to structural market changes, examining the model's performance during periods of market stress, or a combination thereof.

In response to the output of the machine learning model being validated, the method 500 includes outputting 514 the estimated Swap market term premium. For example, outputting 514 the estimated Swap market term premium includes generating a report including the Swap market term premium, transmitting the Swap market term premium to a user device 110, updating a GUI to indicated the Swap market term premium, or a combination thereof.

If the method 500 does not validate the output of the machine learning model, the method 500 returns to step 510 and updates the estimated Swap market term premium.

In some examples, some or all steps of the method 500 are implemented by module(s) of the apparatus 200 and/or 300.

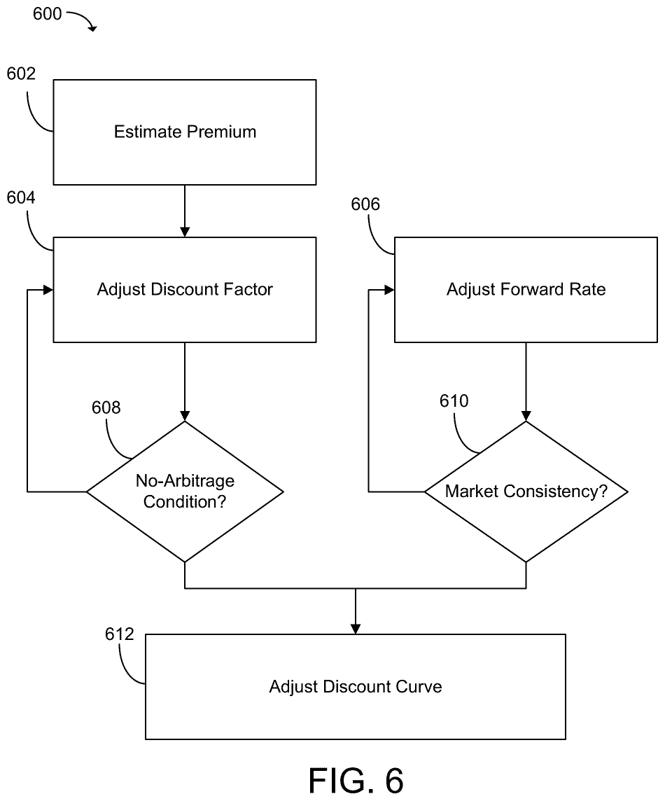

FIG. 6 is a schematic flow chart illustrating one embodiment of a method 600 of adjusting a discount curve. In some examples, the method 600 begins and, in step 602, estimates a Swap market term premium according to any of the methods described herein. In some examples, the method 600 proceeds to adjust 604 a discount factor based at least in part on the estimated Swap market term premium. In some examples, the method also adjusts 606 a forward factor. In some examples, in response to the adjusting 604 of the discount factor, the method 600 determines 608 whether a no-arbitrage condition is maintained based at least in part on the adjusted discount factor. If the condition is not maintained, the method 600 returns to step 604 of adjusting the discount factor.

In some examples, the method 600 determines 610 whether a market consistency condition is maintained based at least in part on the adjusted forward factor. If the market consistency condition is not maintained, the method 600 returns to adjusting 606 the forward factor.

In response to determining that both the no-arbitrage condition and the market consistency condition are maintained, the method 612 adjusts a discount curve based at least in part on an adjusted discount factor and the adjusted forward factor.

In some examples, some or all steps of the method 600 are implemented by module(s) of the apparatus 200 and/or 300.

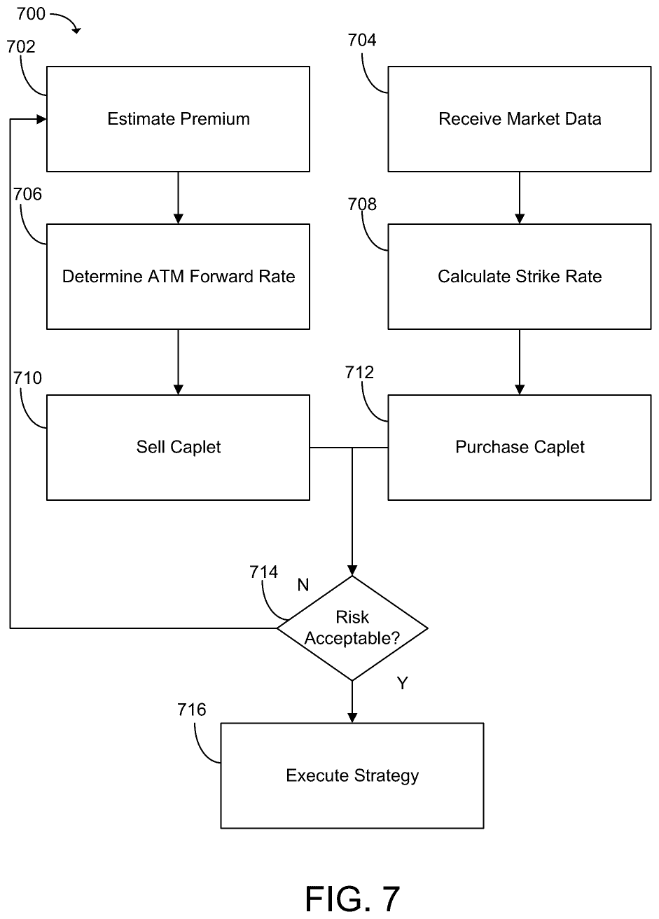

FIG. 7 is a schematic flow chart illustrating one embodiment of a method 700 of executing an investment strategy. In some examples, the method includes a step 702 of estimating a premium according to any of the methods described herein. In some examples, the method 700 includes determining 706 an at-the-money forward rate based at least in part on the estimated premium. In some examples, the method 700 includes selling 710 a first caplet based at least in part on the at-the-money forward rate determined in step 706.

In some examples, the method 700 includes receiving 704 market data and calculating 708 a strike rate based at least in part on the market data. The method 700 includes purchasing 712 a second caplet based at least in part on the calculated strike rate.

In various examples, the method 700 includes determining, based at least in part on the first caplet sale and the second caplet purchase, a risk associated with the estimated premium. In one or more examples, the method 700 includes determining 714 whether the risk is an acceptable risk level. If the method 700 determines that the risk is not an acceptable risk level, the method 700 returns to step 702 of estimating the Swap market term premium. In some examples, estimating 702 the Swap market term premium includes updating the estimated Swap market term premium.

In one or more examples, the method 700 includes, in response to determining that the risk determined in step 714 is acceptable, executing 716 a strategy based at least in part on at least one of: the risk level, the estimated Swap market term premium, or a combination thereof.

In some examples, some or all steps of the method 700 are implemented by module(s) of the apparatus 200 and/or 300.

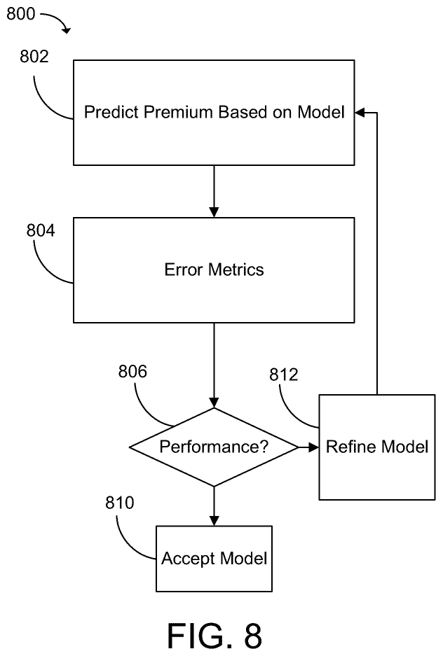

FIG. 8 is a schematic flow chart illustrating one embodiment of a method 800 of refining a machine learning model. In some examples, the machine learning model is a machine learning model for estimating a Swap market term premium, such as the machine learning model described in connection with the machine learning module 316 of the apparatus 300 shown in FIG. 3.

In some examples, the method 800 includes predicting 802 a Swap market term premium based at least in part on the machine learning model. The method 800 includes generating 804 error metrics for the machine learning model.

The method 800 includes determining 806, based at least in part on the determined error metrics, whether a performance of the machine learning model meets a minimum performance standard. The method 800 includes, in response to the performance meeting the minimum performance standard, accepting 810 the model. In some examples, accepting 810 the model includes using the model and/or continuing to use the model to estimate the Swap market term premium. In some examples, the method 800 includes, in response to the performance of the machine learning model not meeting the minimum performance standards, refining 812 the model. After refining 812 the model, the method returns to the step 802 of predicting the premium based at least in part on the refined model.

Although the steps of the method 800 are described above as being implemented with respect to a machine learning model, examples of the present disclosure also include steps of the method 800 being implemented to refine other types of models, such as factor models and linear regression models.

In some examples, some or all steps of the method 800 are implemented by module(s) of the apparatus 200 and/or 300.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for estimating a swap market term premium, comprising:
a market data module that receives market data, the market data comprising a current market condition, the current market condition comprising at least one of: an interest rate, a bond price, a swap rate, a swaption premium, a swaption volatility surface, a cap rate, a cap volatility surface, a floor rate, a floor volatility surface, or a combination thereof;
a future data module that receives additional data, the additional data comprising a future market condition, the future market condition comprising at least one of: an economic indicator, a market structure metric, a supply-demand factor, or a combination thereof; and
a premium module that estimates a swap market term premium by inputting the current market condition and the future market condition into a factor model; and
a report module that generates a report based at least in part on the estimated swap market term premium, the report comprising one or more investment instructions, and transmits the report to a trading system,
wherein at least a portion of said modules comprise one or more of hardware circuits, programmable hardware circuits and executable code, the executable code stored on one or more computer readable storage media.

2. The apparatus of claim 1, further comprising an investment instructions module that generates the investment instructions by determining a change in a relationship between a bond price, a discount interest rate, and a swap rate based at least in part on the estimated swap market term premium.

3. The apparatus of claim 1, wherein:
the premium module estimates the swap market term premium at a first time;
the apparatus further comprises a machine learning module that predicts a swap market term premium at a second time subsequent to the first time by inputting the current market condition and the future market condition into a machine learning model, wherein the machine learning model is trained on historical data, the historical data comprising a realized swap market term premium; and
the report further comprises the predicted swap market term premium.

4. The apparatus of claim 3, further comprising:
an error module that determines an error in the predicted swap market term premium by comparing the predicted swap market term premium to a realized swap market term premium and refines the machine learning model based at least in part on the determined error; and
a learning rate module that adjusts a learning rate of the machine learning model based at least in part on the determined error.

5. The apparatus of claim 3, further comprising a confidence module that generates a confidence interval for the predicted swap market term premium based at least in part on at least one of: the future market condition, the current market condition, estimated swap market term premium, a realized swap market term premium, a calculated uncertainty of the predicted swap market term premium, or a combination thereof.

6. The apparatus of claim 3, further comprising a performance module configured to continuously monitor a performance of the machine learning model, wherein the machine learning module updates the predicted swap market term premium based at least in part on the monitored performance of the machine learning model.

7. The apparatus of claim 1, further comprising:
a monitoring module that continuously monitors the market data and the additional data in real-time; and
an update module that iteratively updates the estimated swap market term premium based at least in part on the monitored market data and the monitored additional data.

8. The apparatus of claim 7, further comprising a user interface module that generates a graphical user interface (“GUI”), the graphical user interface comprising an indication of the estimated swap market term premium, and automatically updates the indication in response to the update module updating the estimated swap market term premium.

9. The apparatus of claim 7, further comprising an alert module that automatically transmits an alert to a computing device associated with a user in response to the update module updating the estimated swap market term premium.

10. The apparatus of claim 1, wherein:
the swap market term premium module computes, based at least in part on the current market condition, at least one of: a level factor, a slope factor, a curvature factor, a principal component factor, or a combination thereof;
the apparatus further comprises a multi-factor regression module that generates a multi-factor regression model for estimating the swap market term premium by performing multi-factor regression analysis based at least in part on the current market condition, a future market condition, and a realized swap market term premium; and
the premium module estimates the swap market term premium based at least in part on an output of the multi-factor regression module.

11. The apparatus of claim 1, further comprising:
a discount factor module that adjusts a standard discount factor based at least in part on the estimated swap market term premium;
a rate modification module that adjusts a forward rate factor based at least in part on the adjusted standard discount factor, a received market price, or a combination thereof;
a no-arbitrage check module that, in response to the rate modification module adjusting the forward rate factor, determines whether a no-arbitrage condition is maintained based at least in part on the adjusted standard discount factor; and
a market consistency module that, in response to the rate modification module adjusting the forward rate factor, determines whether a market consistency condition is maintained based at least in part on the adjusted forward rate factor.

12. The apparatus of claim 11, wherein:
in response to the no-arbitrage check module determining that the no-arbitrage condition is not maintained, the discount factor adjustment module further adjusts the adjusted standard discount factor; and
in response to the market consistency module determining that the market consistency condition is not maintained, the rate modification module further adjusts the forward rate factor.

13. The apparatus of claim 11, further comprising a discount curve module that:
automatically generates an adjusted discount curve based at least in part on the adjusted forward rate factor and the adjusted discount factor in response to the no-arbitrage check module determining that the no-arbitrage condition is maintained and the market consistency module determining that the market consistency condition is maintained; and
outputs the generated adjusted discount curve to at least one of: a graphical user interface (“GUI”), the report module, an alert module configured to transmit a notification indicating the adjusted discount curve to the user, or a combination thereof.

14. The apparatus of claim 11, wherein the standard discount factor module adjusts the standard discount factor by:
applying an exponential premium adjustment to a standard discount factor; and
modifying an interest rate based at least in part on the estimated swap market term premium.

15. The apparatus of claim 11, further comprising:
a fair market value module that determines a fair market value of an interest rate derivative by applying the generated adjusted discount curve; and
a risk metric module that computes a risk metric based at least in part on the generated adjusted discount curve, wherein the report further comprises the determined fair market value, the risk metric, and the estimated swap market term premium.

16. The apparatus of claim 1, further comprising:
an at-the-money forward rate module that determines an at-the-money forward rate based at least in part on the estimated swap market term premium;
a caplet sale module that sells a first caplet, the first caplet having an interest rate equal to a difference between the at-the-money forward rate and the estimated swap market term premium and receives, in response to selling the first caplet, a first caplet premium;
a caplet purchase module that purchases a second caplet concurrently with the caplet sale module selling the first caplet, wherein the second caplet has an interest rate equal to the at-the-money forward rate, and pays, in response to buying the second caplet, a second caplet premium; and
a premium collection module that receives a net caplet premium, wherein the net caplet premium is based at least in part on a difference between the first caplet premium and the second caplet premium.

17. The apparatus of claim 16, the apparatus further comprising a risk limit module that, based at least in part on the net caplet premium, quantifies a risk and determines whether the risk is greater than or equal to a threshold risk, wherein the swap market term premium module updates the estimated swap market term premium in response to the risk limit module determining that the risk is greater than or equal to the threshold risk.

18. The apparatus of claim 17, further comprising a strategy execution module configured to generate and execute a strategy in response to the risk limit module determining that the risk is less than the threshold risk, wherein executing the strategy comprises at least one of: purchasing a caplet, selling a caplet, receiving a premium, paying a premium, performing a transaction, or a combination thereof.

19. A method, comprising:
receiving market data, the market data comprising a current market condition, the current market condition comprising at least one of: an interest rate, a bond price, a swap rate, a swaption premium, a swaption volatility surface, a cap rate, a cap volatility surface, a floor rate, a floor volatility surface, or a combination thereof;
receiving additional data, the additional data comprising a future market condition, the future market condition comprising at least one of: an economic indicator, a market structure metric, a supply-demand factor, or a combination thereof; and
estimating a swap market term premium by inputting the current market condition and the future market condition into a factor model; and
generating a report based at least in part on the estimated swap market term premium, the report comprising one or more investment instructions; and
transmitting the report to a trading system.

20. A computer program product, the computer program product comprising a computer readable storage medium storing code, the code being configured to be executable by a processor to perform operations comprising:
receiving market data, the market data comprising a current market condition, the current market condition comprising at least one of: an interest rate, a bond price, a swap rate, a swaption premium, a swaption volatility surface, a cap rate, a cap volatility surface, a floor rate, a floor volatility surface, or a combination thereof;
receiving additional data, the additional data comprising a future market condition, the future market condition comprising at least one of: an economic indicator, a market structure metric, a supply-demand factor, or a combination thereof; and
estimating a swap market term premium by the current market condition and the future market condition into a factor model; and
generating a report based at least in part on the estimated swap market term premium, the report comprising one or more investment instructions; and
transmitting the report to a trading system.
